(19) United States
(12) Patent Application Publication
(10) Pub. No.: US 2001/0007617 A1
(43) Pub. Date: Jul. 12, 2001

(54) Image forming apparatus

(75) Inventor: Takahide Nakamura, Niigata (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/758,821

(22) Filed: Jan. 11, 2001

(30) Foreign Application Priority Data
Jan. 12, 2000 (JP) 3424 /2000

(51) Int. Cl. G03G 15/01

(52) U.S. Cl. 399/298; 399/301

(57) ABSTRACT

A detection hole is formed in a belt. When the detection hole arrives at the reference/edge sensor, the light from the reference signal detection light emitting element passes through the detection hole, and then arrives at the reference signal detection light receiving element. The controller operates so that data is transmitted to the laser scanner units at the wiring timing of each data based on the reference signal. Furthermore, the reference/edge sensor has another pair of light emitting and receiving elements, i.e., an edge signal detection light emitting element and an edge signal detection light receiving element. The belt is so attached that its end portion can always remain within a detectable area. In addition, corresponding to an area in which the belt shields a detectable range, it is possible to obtain an edge signal changing in analogue manner. In accordance with a change of the edge signal, the controller can thus control a steering roller.

### BACKGROUND OF THE INVENTION

1. Field of the Invention

The present invention relates to an image forming apparatus, particularly to an image forming apparatus employing an electrophotographic technology to produce a full color image by forming one upon another a plurality of images on a belt, followed by transferring and fixing the full color image to a predetermined paper and thus obtaining a desired final image.

2. Description of the Related Art

Conventionally, an image forming apparatus employing the electrophotographic technology has long been used in a printer, a copying machine and a facsimile device. For obtaining a full color image by using the electrophotographic technology, there have been suggested various methods which have already been put into practical use. For example, there has been known a method in which a plurality of laser scanners are used to form one upon another several colors of images on a belt-like photosensitive material.

However, when using the image forming apparatus involving the use of the above-described method, it is necessary to have a reference to effect an alignment among data writing positions of various lasers. Further, if a meandering movement occurs in the belt of the image forming apparatus, some irregularities in concentration and ununiformities in color will happen.

In order to solve the above-mentioned problems, Japanese Unexamined Utility Model Publication (JP-U) No. 110609/1983 has disclosed a method for preventing the meandering movement of the belt in an image forming apparatus. According to this utility model publication, a belt-like photosensitive member is bridged between and engaged around a drive roller and an idler roller. Meanwhile, a belt sensor is disposed in the vicinity of an end of the belt, while the tension with respect to the belt of the idle roller is changed in response to a belt bias signal fed from the belt sensor, thereby preventing an undesired bias. However, the above utility model publication teaches nothing about how to effect an alignment among data writing positions.

In a conventional image forming apparatus, in order to effect an alignment among various data writing positions and to prevent the meandering movement of the belt, it is required to separately provide a reference position detecting means and a moved amount detecting means, with the reference position detecting means being used to detect a reference position in the circulation direction of the belt, and with the moved amount detecting means being used to detect a moved amount of the belt in a scanning direction (the scanning direction of the laser light). In this way, various data writing timings may be set properly on the base of the reference position, and the belt is exposed and scanned by each laser light. Meanwhile, a steering roller is controlled in accordance with a detected signal indicating a moved amount of the belt in the scanning direction, thereby obtaining an image free from any irregularities in concentration and any ununiformities in color.

However, with the conventional image forming apparatus described in the above, since the reference position detecting means is provided independently from the detecting means for detecting a moved amount of the belt in the scanning direction, the apparatus as a whole is quite complex in its structure and considerably large in its size.

### SUMMARY OF THE INVENTION

Accordingly, it is an object of the present invention to provide an improved image forming apparatus which includes a reference position detecting means for detecting a reference position of a belt in its circulation direction, and another detecting means for detecting a moved amount of a belt in a scanning direction, with the apparatus as a whole being simplified in its structure and compact in its size.

According to the present invention, an improved image forming apparatus is proved which comprises a belt for forming one upon another several colors of images in order to obtain a full color image, a reference sensor for detecting a reference position of the belt in its circulation direction and for producing a reference signal all for the purpose of effecting the formation of the several colors of the images on the belt, and an edge sensor for monitoring an edge position of the belt. In particular, the reference sensor and the edge sensor are combined together so as to form an integral structure.

### BRIEF DESCRIPTION OF THE DRAWINGS

FIG. 1 is an explanatory view showing the entire structure of an image forming apparatus formed according to an embodiment of the present invention.

FIG. 2 is a block diagram showing a relationship among a belt unit, laser scanner units and a controller in the image forming apparatus formed according to the embodiment of the present invention.

FIG. 3 is a perspective view showing a belt used in the image forming apparatus formed according to the embodiment of the present invention.

FIG. 4 is a side view showing a reference/edge sensor used in the image forming apparatus formed according to the embodiment of the present invention.

### DESCRIPTION OF THE PREFERRED EMBODIMENTS

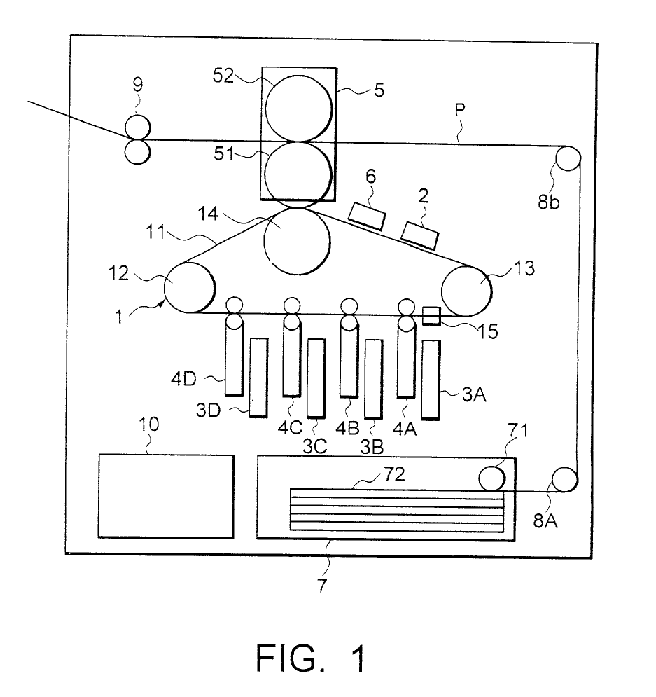

An embodiment of the present invention will be described below with reference to FIGS. 1 to 4.

Referring to FIG. 1, the image forming apparatus of the present invention comprises a belt unit 1, an electrifier 2, laser scanner units 3A, 3B, 3C and 3D, development units 4A, 4B, 4C and 4D, a transfer/fixing unit 5, an electricity remover 6, a paper feeding unit 7, conveying rollers 8A and 8B, discharge rollers 9, and a controller 10.

The belt unit 1 includes a belt 11, a driving roller 12, a steering roller 13, a transfer backup roller 14, and a reference/edge sensor 15. The transfer/fixing unit 5 includes a transfer roller 51 and a fixing roller 52. The paper feeding unit 7 includes a paper feeding roller 71. A plurality of papers 72 are set in this paper feeding unit 7.

The belt 11 is a belt-like photosensitive material. The electrifier 2 is provided to electrify the surface of the belt 11. The laser scanner units 3A, 3B, 3C and 3D are provided to produce laser lights to irradiate the belt 11 so as to form latent images thereof. Here, the reason as to why four laser scanner units are provided may be explained as follows. Namely, the provision of the four laser scanner units can form latent images for four kinds of colors, including yellow, magenta, cyan and black. The development units 4A, 4B, 4C and 4D have respectively four colors of developing powders, including yellow, magenta, cyan and black, thereby forming latent images on the belt 11. In this way, once the belt 11 passes through the four development units, a full color toner image will be formed on the belt 11. This toner image is then transferred to a transfer roller 51 in a position where the transfer backup roller 14 gets in contact with the transfer roller 51. Meanwhile, the electricity remover 6 operates to remove the electricity from the surface of the belt 11, so as to get prepared for a next process of forming an electrophotography image.

On the other hand, a plurality of papers 72 are set in the paper feeding unit 7 and are pickup by a paper feeding roller 71, so as to be conveyed along a paper transporting course P by virtue of two conveying rollers 8A and 8B. In an area of the transfer/fixing unit 5, the toner image on the transfer roller 51 is transferred to the paper and then fixed thereon by virtue of both the fixing roller 52 and the transfer roller 51, thereby obtaining a final image. The paper with the final image formed thereon is discharged out from the apparatus by means of a pair of discharge rollers 9. Here, the controller 10 is provided to control the operations of various units.

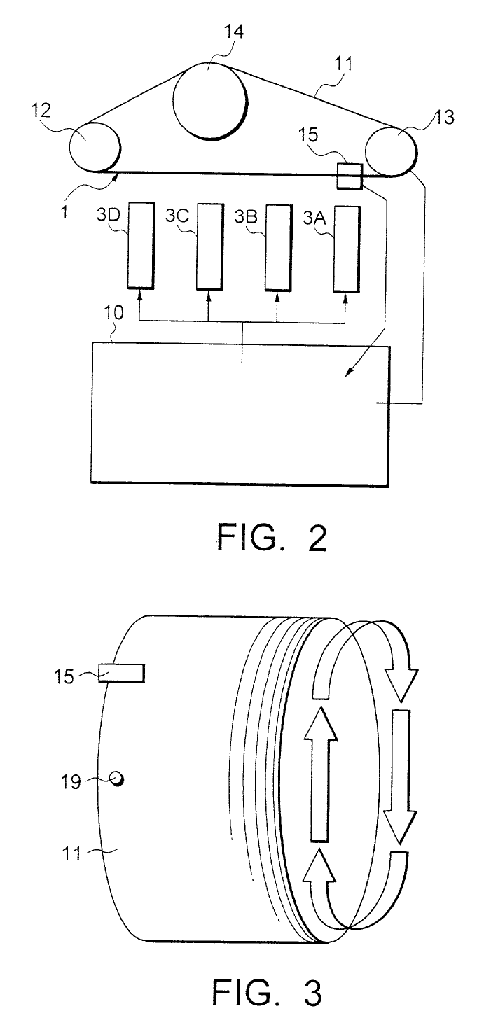

FIG. 2 is a block diagram showing a relationship among the belt unit 1, the laser scanner units 3A, 3B, 3C, 3D, and the controller 10. A driving roller 12 is driven by a motor (not shown) serving as a driving source, thereby driving the belt 11. The steering roller 13 is so formed and constructed that its steering angle is changeable, thereby preventing a meandering movement of the belt 11. The reference/edge sensor 15 is provided to detect a reference signal and an edge signal (monitoring an end position of the belt 11) once in each circulation of the belt. The controller 10 is provided to control the writing timing of each data, in accordance with the reference signal fed from the reference/edge sensor 15, thereby effecting a desired steering control in accordance with an edge signal. At this time, the laser scanner units 3A, 3B, 3C and 3D are operated to expose and scan the data fed from the controller 10 on the belt 11.

FIG. 3 is a perspective view showing the belt 11. A detection hole 19 is formed in the belt 11 in order to obtain a reference signal.

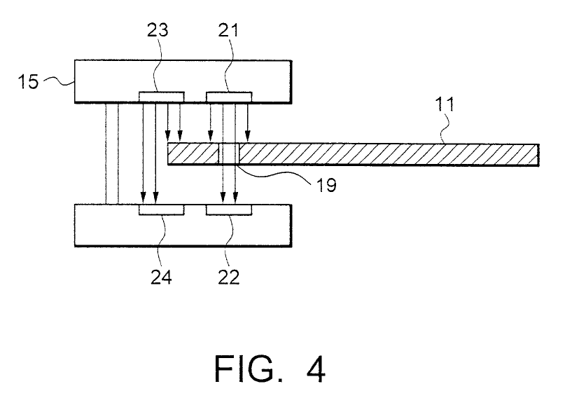

FIG. 4 is a side view showing the reference/edge sensor 15. In order to detect a reference signal, a reference signal detection light emitting element 21 and a reference signal detection light receiving element 22 are provided in alignment with the detection hole 19 formed in the belt 11, in a manner such that the detection light emitting element 21 and the detection light receiving element 22 are facing each other. Furthermore, in order to detect the edge of the belt 11, an edge signal detection light emitting element 23 and an edge signal detection light receiving element 24 are also provided facing each other.

Next, the operation of the apparatus will be described in the following with reference to FIG. 3. As shown in the drawing, the detection hole 19 is formed in the belt 11 in order to obtain a reference signal. With the rotation of the driving roller 12, the belt 11 is turned. When the detection hole 19 arrives at the reference/edge sensor 15, the light from the reference signal detection light emitting element 21 of the reference/edge sensor 15 passes through the detection hole 19 of the belt 11 and then arrives at the reference signal detection light receiving element 22. In this way, an electric current will flow to an element on the light reception side, thus obtaining a reference signal. The reference signal is then fed to the controller 10. Subsequently, the reference signal is fed to the controller 10 and the controller 10 operates so that data is transmitted to the laser scanner units 3A, 3B, 3C and 3D at the writing timing of each data based on the reference signal.

Furthermore, the reference/edge sensor 15 has another pair of light emitting and receiving elements, i.e., the edge signal detection light emitting element 23 and the edge signal detection light receiving element 24. Specifically, by virtue of the edge signal detection light emitting element 23, a light spreading from the light emitting element is allowed to pass through a lens so as to be converted into a parallel light, thereby increasing the light irradiation area. Meanwhile, as the edge signal detection light receiving element 24, a large area type light receiving element or a plurality of light receiving elements may be used so as to receive a light spreading hereto and then converge the light by means of a lens, thereby increasing a light detectable area. In fact, the belt 11 is attached in advance in a manner such that an end portion of the belt 11 can always remain within the detectable area. Further, corresponding to an area in which the belt 11 shields a detectable range, a change will be caused in an area of a light arriving at the edge signal detection light receiving element 24. As a result, there will be a change in an electric current flowing into an element of the edge signal detection light receiving element 24, thus making it possible to obtain an edge signal changing in analogue manner. The edge signal is then fed to the controller 10 which, in accordance with a change of the edge signal, controls the steering roller 13 so as to effect an amount of steering predetermined in advance.

Although it has been described in the present embodiment that a hole is formed in a belt for use in detecting a reference signal, it is also possible that a light transmissible transparent window may be formed on the belt instead of forming a hole thereon. Alternatively, it is also allowed to form a reflective mark (having a reflectance which is different from that of a material forming the belt), thereby obtaining a reference signal using a light reflecting type rather than a light transmitting type. In addition, it is also possible that the reference signal detection light emitting element may be made integral with the edge signal detection light emitting element to form a common light emitting means. In this way, it is permitted to produce an apparatus having a simplified structure and a reduced size.

Although the present embodiment describes an example of an image forming apparatus in which a plurality of images are formed one upon another on a belt-like photosensitive material, the present invention can also be applied to another image forming apparatus in which a plurality of images are formed one upon another on an intermediate transfer belt. An example of such an alternative may be described in detail below. Namely, a plurality of photosensitive drums are prepared, a plurality of images are then formed on these photosensitive drums by virtue of the laser scanner units and the development units, followed by placing these images one upon another on the intermediate transfer belt, thereby forming a full color image. Further, a detection hole is formed in the intermediate transfer belt so as to obtain a reference signal (for use in the writing operation of the laser scanner units) by virtue of a reference signal sensor. Moreover, in order to monitor the meandering movement of the intermediate transfer belt, an edge position is obtained by an edge sensor. Specifically, the reference sensor and the edge sensor are combined with each other so as to form an integral structure.

As may be understood from the above description, with the use of the present invention, it is possible to obtain at least the following effects. Namely, since the sensor for obtaining a reference signal for determining data writing timings may be made integral with the sensor for obtaining an edge signal for monitorring the meandering movement of a belt, it is permitted to produce an improved image forming apparatus which is compact in size and low in price.

Usually, an assembling operation for producing an image forming apparatus requires that the above two sensors be installed with a high precision. Since the two sensors may be combined together to form an integral structure, the present invention needs only fewer steps to complete the manufacturing of an image forming apparatus than the case in which the two sensors are installed separately.

What is claimed is:

1. An image forming apparatus comprising:
a belt for forming one upon another several colors of images in order to obtain a full color image;
a reference sensor for detecting a reference position of the belt in its circulation direction and producing a reference signal, in order to effect the formation of the several colors of the images on the belt; and
an edge sensor for monitoring an edge position of the belt;
wherein the reference sensor and the edge sensor are combined together so as to form an integral structure.

2. An image forming apparatus according to claim 1, wherein a detection hole is formed in the belt, the reference sensor includes a light emitting element and a light receiving element for receiving a light emitted from the light emitting element through the detection hole.

3. An image forming apparatus according to claim 1, wherein a light transmissible portion is formed in the belt, the reference sensor includes a light emitting element and a light receiving element for receiving a light emitted from the light emitting element through the light transmissible portion.

4. An image forming apparatus according to claim 1, wherein a reflective mark is formed in the belt, the reference sensor includes a light emitting element and a light receiving element for receiving a light emitted from the light emitting element and reflected by the reflective mark.

5. An image forming apparatus according to claim 1, wherein the edge sensor includes a light emitting element and a light receiving element, the light emitting element of the reference sensor is integrally formed with the light emitting element of the edge sensor.

6. An image forming apparatus according to claim 1, wherein the belt is made of a photosensitive material.

7. An image forming apparatus according to claim 1, wherein the belt is an intermediate transfer belt.
